(19) United States
(12) Patent Application Publication
(10) Pub. No.: US 2018/0342026 A1
(43) Pub. Date: Nov. 29, 2018

(54) SYSTEM AND METHOD FOR GENERATING SPECIALTY PROPERTY DEMAND INDEX

(71) Applicant: A Place for Mom, Inc., Seattle, WA (US)

(72) Inventor: Benjamin Dalton Oliver Hanowell, Seattle, WA (US)

(21) Appl. No.: 15/984,039

(22) Filed: May 18, 2018

Related U.S. Application Data
(60) Provisional application No. 62/510,978, filed on May 25, 2017.

(51) Int. Cl. G06Q 50/16; G06F 17/30; G06N 7/00; G06N 99/00

(52) U.S. Cl. CPC G06Q 50/163; G06F 17/30321; G06N 99/005; G06F 17/30867; G06N 7/005; G06F 17/3087

(57) ABSTRACT

Systems, apparatuses, and methods for enabling a user to collect, assemble, manipulate, and utilize data regarding demand in one or more specific markets about specialty properties, such as assisted living, long-term care facilities, and the like. Several factors will affect a specific market and the ebb and flow of regional costs, regional demand, regional demographics, and regional econometrics. Further, intra-regional and extra-regional data may also reflect the behavior of individuals in a market based on additional factors. Collecting this data and assigning relative values to the data based on follow-on activities, such as actual inquiries into property, lead generation for specific properties and move-in data for specific properties leads to a ever-changing demand index that is continuously updated through a machine-learning algorithm by which demand index data may be gleaned at any given moment in time for any specific region.

### CLAIM TO PRIORITY APPLICATION

This application claims the benefit of U.S. Provisional Application No. 62/510,978, entitled “System and Method for Generating Specialty Property Demand Index,” filed May 25, 2017, which is incorporated by reference in its entirety herein for all purposes.

### CROSS-REFERENCE TO RELATED APPLICATIONS

This application is cross-related to the following U.S. patent applications: (Attorney Docket No 126129.1103) U.S. patent application Ser. No. ______, entitled “System and Method for Generating Specialty Property Cost Index,” filed May ______, 2018; (Attorney Docket No 126129.1303) U.S. patent application Ser. No. ______, entitled “System and Method for Generating Cost Estimates for Specialty Property,” filed May 2018; (Attorney Docket No 126129.1603) U.S. patent application Ser. No. ______, entitled “System and Method for Generating Same Property Cost Growth Estimate in Changing Inventory of Specialty Property,” filed May ______, 2018; (Attorney Docket No 126129.1703) U.S. patent application Ser. No. ______, entitled “System and Method for Generating Variable Importance Factors in Specialty Property Data,” filed May ______, 2018; (Attorney Docket No 126129.1803) U.S. patent application Ser. No. ______, entitled “System and Method for Generating Indexed Specialty Property Data Influenced by Geographic, Econometric, and Demographic Data,” filed May ______, 2018; (Attorney Docket No 126129.1903) U.S. patent application Ser. No. ______, entitled “System and Method for Identifying Outlier Data in Indexed Specialty Property Data,” filed May ______, 2018; (Attorney Docket No 126129.2003) U.S. patent application Ser. No. ______, entitled “System and Method for Generating Indexed Specialty Property Data From Transactional Move-In Data,” filed May ______, 2018. Each of these are incorporated by reference in their entireties herein for all purposes.

### BACKGROUND

Specialty property, such as senior living and assisted care facilities, are growing in demand in the United States and other countries due to a rapidly aging population. As modern medical breakthroughs allow for longer and more actives lives, the demand for senior living facilities continues to rise. Predicting the cost and demand for specialty property can be a difficult task with disparate information available across disparate social, geographic, econometric and demographic strata.

Further, various conventional methods for predicting cost and demand in more conventional properties does not take into account a number of factors unique to specialty property demand, such as the services that may typically be purchased at the initial transaction. Further yet, additional externalities such as walkability and service provider availability may further cloud the ability to predict cost and demand data for specialty properties across ever-changing geographic, econometric and demographic populations.

### BRIEF DESCRIPTION OF DRAWINGS

The drawings described herein are for illustrative purposes only of selected embodiments and not all possible implementations, and are not intended to limit the scope of the present disclosure.

FIG. 1 is a block diagram of a networked computing environment for facilitating data collection, analysis and consumption in a specialty property analytics and machine system according to an embodiment of the present disclosure;

FIG. 2 is an exemplary computing environment that is a suitable representation of any computing device that is part of the system of FIG. 1 according to an embodiment of the present disclosure;

FIG. 3 is a block diagram of a machine-learning module of the server of FIG. 1 according to an embodiment of the subject matter disclosed herein; and

FIG. 4 is a method flow chart for demand index data generation using the system of FIG. 1-3 according to an embodiment of the subject matter disclosed herein.

Corresponding reference numerals indicate corresponding parts throughout the several views of the drawings.

### DETAILED DESCRIPTION

The subject matter of embodiments disclosed herein is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Embodiments will be described more fully hereinafter with reference to the accompanying drawings, which form a part hereof, and which show, by way of illustration, exemplary embodiments by which the systems and methods described herein may be practiced. The systems and methods may, however, be embodied in many different forms and should not be construed as limited to the embodiments set forth herein; rather, these embodiments are provided so that this disclosure will satisfy the statutory requirements and convey the scope of the subject matter to those skilled in the art.

Among other things, the present subject matter may be embodied in whole or in part as a system, as one or more methods, or as one or more devices. Embodiments may take the form of a hardware-implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, controller, or the like) that is part of a client device, server, network element, or other form of computing device/platform and that is programmed with a set of executable instructions (e.g., software instructions), where the instructions may be stored in a suitable data storage element. In some embodiments, one or more of the operations, functions, processes, or methods described herein may be implemented by a specialized form of hardware, such as a programmable gate array, application specific integrated circuit (ASIC), or the like. The following detailed description is, therefore, not to be taken in a limiting sense.

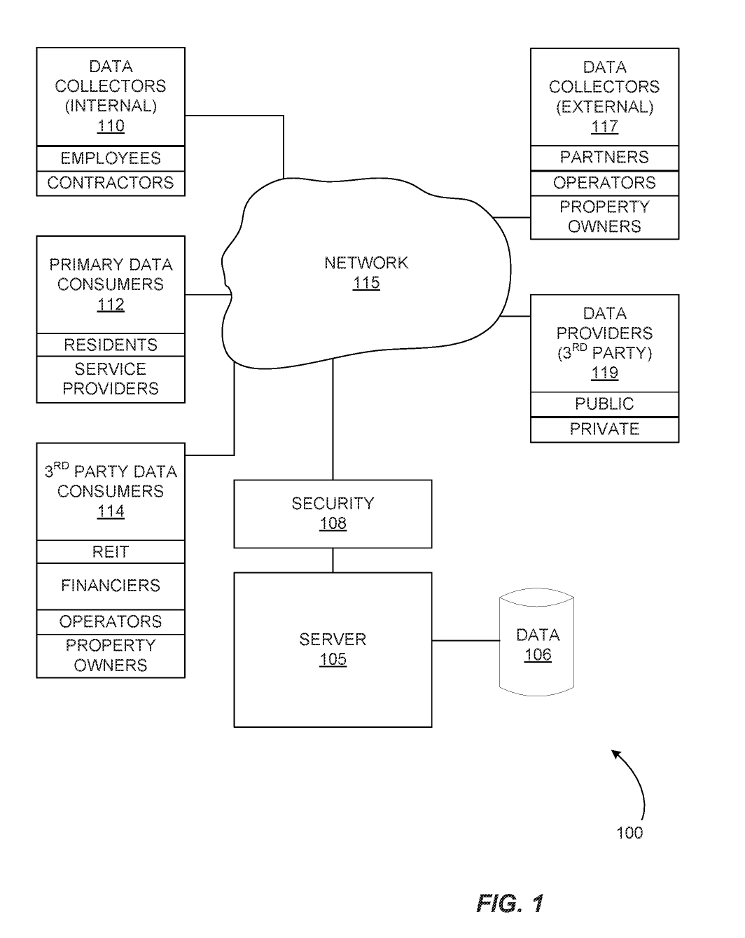

Prior to discussing specific details of the embodiments described herein, a brief overview of the subject matter is presented. Generally, one or more embodiments are directed to systems, apparatuses, and methods for enabling a user to collect, assemble, manipulate, and utilize data regarding demand in one or more specific markets about specialty properties, such as assisted living, long-term care facilities, and the like. Several factors will affect a specific market and the ebb and flow of regional costs, regional demand, regional demographics, and regional econometrics. Further, intra-regional and extra-regional data may also reflect the behavior of individuals in a market based on additional factors. Collecting this data and assigning relative values to the data based on follow-on activities, such as actual inquiries into property, lead generation for specific properties and move-in data for specific properties leads to a ever-changing demand index that is continuously updated through a machine-learning algorithm by which demand index data may be gleaned at any given moment in time for any specific region. These and other aspects of the specific embodiments are discussed below with respect to FIGS. 1-4.

FIG. 1 is a block diagram of a networked computing environment 100 for facilitating data collection, analysis, and consumption in a specialty property analytics and machine system according to an embodiment of the present disclosure. The environment 100 includes a number of different computing devices that may each be coupled to a computer network 115. The computer network 115 may be the internet, and internal LAN or WAN or any combination of known computer network architectures. The environment 100 may include a server computer 105 having several internal computing modules and components configured with computer-executable instructions for facilitating the collection, analysis, assembly, manipulation, storing, and reporting of data about specialty property costs and demand. The server 105 may store the data and executable instructions in a database or memory 106. The server 105 may also be behind a security firewall 108 that may require username and password credentials for access to the data and computer-executable instructions in the memory 106.

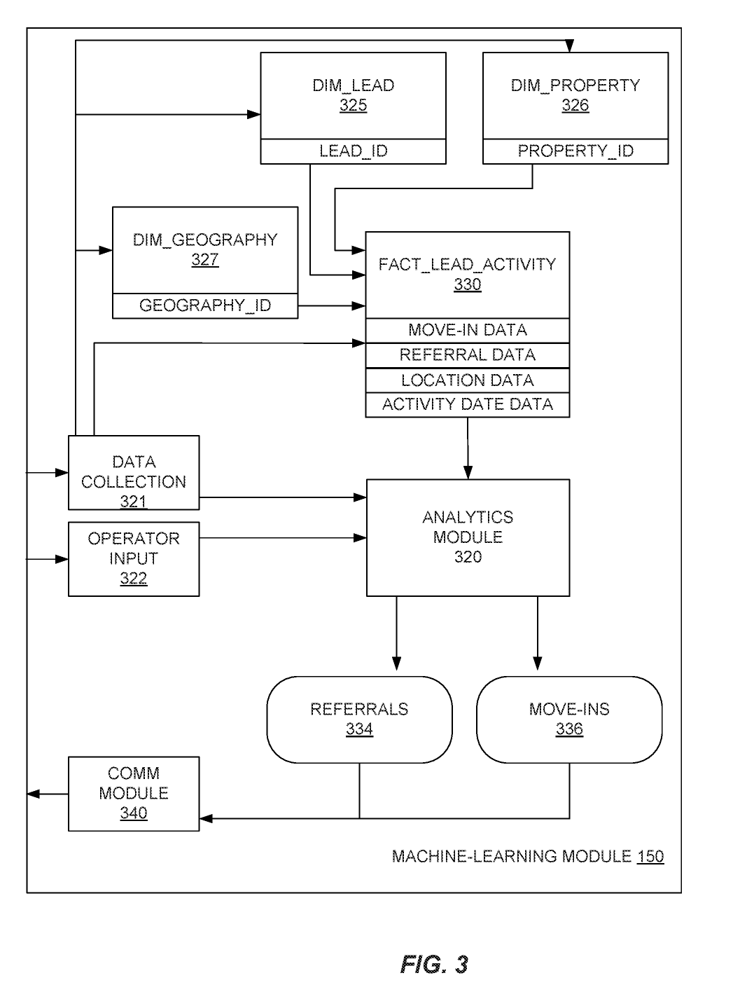

The environment 100 may further include several additional computing entities for data collection, provision, and consumption. These entities include internal data collectors 110, such as employee computing devices and contractor computing devices. Internal data collectors 110 may typically be associated with a company or business entity that administers the server computer 105. As such, internal data collectors 110 may also be located behind the firewall 108 with direct access to the server computer (without using any external network 115). Internal data collectors may collect and assimilate data from various sources of data regarding specialty properties. Such data collected may include data from potential resident inquiries, leads data from advisors working with/for the business entity, and move-in data from property owners and operators. Many other examples of collected data exist but are discussed further below with respect to additional embodiments. The aspects of the specific data collected by internal data collectors 110 is described below with respect to FIG. 3.

The environment 100 may further include external data collectors 117, such as partners, operators and property owners. Internal data collectors 110 may typically be third party businesses that have a business relationship with the company or business entity that administers the server computer 105. External data collectors 110 may typically be located outside of the firewall 108 without direct access to the server computer such that credentials are used through the external network 115. Such data collected may include data from potential resident inquiries, leads data from advisors working with/for the business entity, and move-in data from property owners and operators. Many other examples of collected data exist but are discussed further below with respect to additional embodiments. The aspects of the specific data collected by external data collectors 117 is also described below with respect to FIG. 3.

The environment 100 may further include third-party data providers 119, that includes private entities such as the American Community Survey (ACS) as well as public entities such as the US Department of Housing and Urban Development (HUD). These third-party data providers may provide geographic, econometric, and demographic data to further lend insights into the collected data about potential resident inquiries, leads, and move-in data. Many other examples of third-party data exist but are discussed further below with respect to additional embodiments.

The environment 100 may further include primary data consumers 112, such as existing and potential residents as well as service providers. The environment 100 may further include, and third-party data consumers 114, such as Real-Estate Investment Trusts (REITs), financiers, third-party operators, and third-party property owners. These primary data consumers 112 and third-party data consumers 114 may use the assimilated data in the database collected from data collectors and third parties to glean information about one or more specialty property markets. Such data consumed may include the very data from potential resident inquiries, leads data and move-in data. Many other examples of consumed data exist but are discussed further below with respect to additional embodiments as well as discussed in related patent applications.

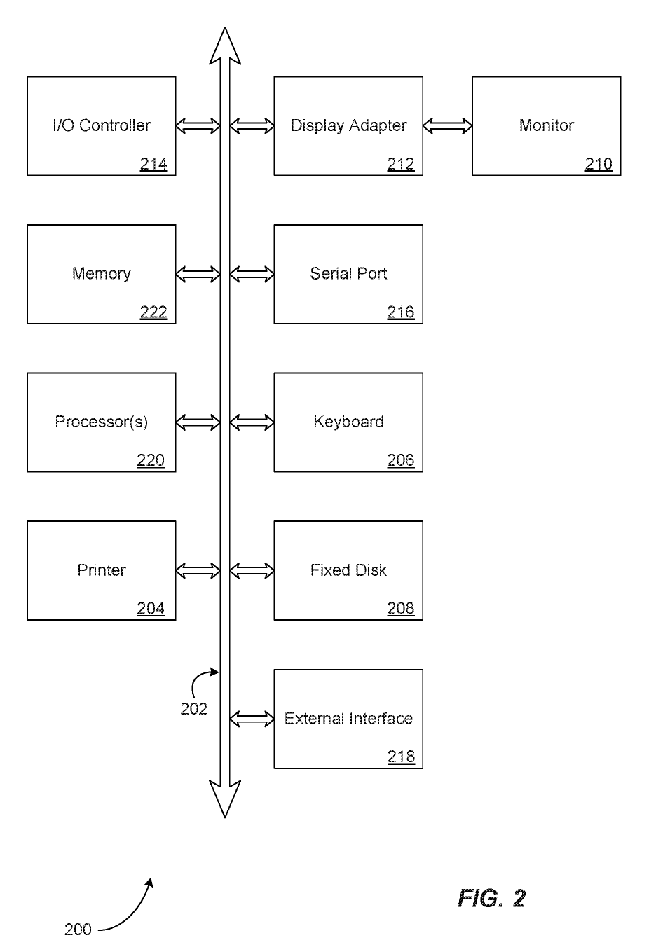

Collectively, the data collected and consumed may be stored in the database 106 and manipulated in various ways described below by the server computer 105. Prior to discussing aspects of the operation and data collection and consumption as well as eth cultivation of the database, a brief description of any one of the computing devices discussed above is provided with respect to FIG. 2.

FIG. 2 is a diagram illustrating elements or components that may be present in a computer device or system configured to implement a method, process, function, or operation in accordance with an embodiment. In accordance with one or more embodiments, the system, apparatus, methods, processes, functions, and/or operations for enabling efficient configuration and presentation of a user interface to a user may be wholly or partially implemented in the form of a set of instructions executed by one or more programmed computer processors such as a master control unit (MCU), central processing unit (CPU), or microprocessor. Such processors may be incorporated in an apparatus, server, client or other computing or data processing device operated by, or in communication with, other components of the system. Such computing devices may further be one or more of the group including: a desktop computer, as server computer, a laptop computer, a handheld computer, a tablet computer, a smart phone, a personal data assistant, and a rack computing device.

As an example, FIG. 2 is a diagram illustrating elements or components that may be present in a computer device or system 200 configured to implement a method, process, function, or operation in accordance with an embodiment. The subsystems shown in FIG. 2 are interconnected via a system bus 202. Additional subsystems include a printer 204, a keyboard 206, a fixed disk 208, and a monitor 210, which is coupled to a display adapter 212. Peripherals and input/output (I/O) devices, which couple to an I/O controller 214, can be connected to the computer system by any number of means known in the art, such as a serial port 216. For example, the serial port 216 or an external interface 218 can be utilized to connect the computer device 200 to further devices and/or systems not shown in FIG. 2 including a wide area network such as the Internet, a mouse input device, and/or a scanner. The interconnection via the system bus 202 allows one or more processors 220 to communicate with each subsystem and to control the execution of instructions that may be stored in a system memory 222 and/or the fixed disk 208, as well as the exchange of information between subsystems. The system memory 222 and/or the fixed disk 208 may embody a tangible computer-readable medium.

It should be understood that the present disclosure as described above can be implemented in the form of control logic using computer software in a modular or integrated manner. Based on the disclosure and teachings provided herein, a person of ordinary skill in the art will know and appreciate other ways and/or methods to implement the present disclosure using hardware and a combination of hardware and software.

Any of the software components, processes or functions described in this application may be implemented as software code to be executed by a processor using any suitable computer language such as, for example, R, Java, JavaScript, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

FIG. 3 is a block diagram of a machine-learning module 350 of the server 105 of FIG. 1 according to an embodiment of the subject matter disclosed herein. The machine-learning module 350 may include various programmatic modules and execution blocks for accomplishing various tasks and computations with the context of the system and methods discussed herein. As discussed above, this may be accomplished through the execution of computer-executable instructions stored on a non-transitory computer readable medium. To this end, the various modules and execution blocks are described next.

The machine-learning module 350 may include lists of data delineated by various identifications that are indicative of the type and nature of the information stored in the ordered lists. At the outset, these lists, in this embodiment, include a first list of lead data called DIM_LEAD 325. A “lead” includes data about an individual who is interested in acquiring rights and services at a specialty property and each record in DIM_LEAD 325 may be identified by a LEAD_ID. In this embodiment, the rights and services may include rents and personal care services at a senior living facility. In other embodiments, the specialty property is not necessarily a senior care facility or senior housing. The LEAD_ID may also include specific geographic data about a preferred location of a specialty property. The data that populates this list may be received at the machine-learning module 350 via a data collection module 321 that facilitates communications from various data collectors and third-party data providers as discussed with respect to FIG. 1. The information in DIM_LEAD 325 as described here may be collected chiefly by Senior Living Advisors, but could also be collected by third-party contractors (see data collectors 110 of FIG. 1).

Another list of data includes data about various properties in the pool of available or used specialty properties and this list is called DIM_PROPERY 326. The records in this list may include data about services provided at each property as well as cost data, availability, and specific location. DIM_PROPERTY records may also include a history of property attributes over time for each PROPERTY_ID, so that leads can be matched to the property with each respective leads attributes. Records in DIM_PROPERY 326 are identified by a unique identifier called PROPERTY_ID. The data that populates this list may be received at the machine-learning module 350 via a data collection module 321 that facilitates communications from various data collectors and third-party data providers as discussed with respect to FIG. 1. DIM_PROPERTY 326 may be typically obtained from from partners, operators, and property owners (117 of FIG. 1), but additional information about the property (such as its age, number of units of a given unit type, recent renovation, etc.) may come from 3rd party private or public sources (119 of FIG. 1).

Another list of data includes data about various geographic locations in the pool of available or used specialty properties and this list is called DIM_GEOGRAPHY 327. The records in DIM_GEOGRAPHY 327 may include data about the geographic locations of all properties such as ZIP code, county, city, metropolitan area, state, and region. The records here may also include data about weather associated with various geographic location along with time and season factors. For example, one could collect data about time-stamped weather event to examine the impact of weather on the demand index. Records in this list are identified by a unique identifier called GEOGRAPHY_ID. The data that populates this list may be received at the machine-learning module 350 via a data collection module 321 that facilitates communications from various data collectors and third-party data providers as discussed with respect to FIG. 1. DIM_GEOGRAPHY 327 is collected from addresses of the properties, which are provided by partners, property owners, and operators (117 of FIG. 1), and addresses may be geotagged using public and private 3rd party sources (119 of FIG. 1) to acquire ZIP, county, city, metro, state, and region data.

All data from these various lists of data may be updated from time-to-time as various events occur or new data is collected or provided by various data collectors and third-party data providers via data collection module 321. As events takes place, a new conglomerate list, FACT_LEAD_ACTIVITY 330, may be initiated and populated with various events that occur along with associated relevant data from the lists. Records in FACT_LEAD_ACTIVITY 330 include data with regard to lead events and move-in events. A lead event is defined as the event in which an advisor refers a specific property to a potential user of services. A move-in event is defined as an event in which a user of services moves into a recommended property from a lead. As such, the records will also include specific data about the dates of the activity underlying the event as well as specific data about the recommended property (e.g., cost, location, region, demographics of the area) and the user (or potential user) of services (e.g., demographics, budget, services desired).

As mentioned, all data from these various lists of data may be updated from time-to-time as various events occur or new data is collected or provided by various data collectors and third-party data providers via data collection module 321. When an action takes place, such as a referral of a property to a lead or a lead moving in to a referred property, an activity record may be created in the list FACT_LEAD_ACTIVITY 330. This information may include data drawn from the initial three lists discussed above when a specific action takes place. Thus, each record will include a LEAD_ID, a PROPERTY_ID, and a GEOGRAPHY_ID that may be indexed with additional data such as activity type (e.g., referral or move-in) and activity date. For example, a new inquiry may be made, a new lead may be generated, a new property may become part of the property pool, geographic data may be updated as ZIP codes or city/county lines shift, and the like. Further, collected data could be used to update or populate DIM_PROPERY 326, DIM_LEAD 325, DIM_GEOGRAPHY 327 and FACT_LEAD_ACTIVITY 330 in that collected data about economics, demography, and geography (including weather) may be assimilated in any of the lists discussed above.

All data in FACT_LEAD_ACTIVITY 330 may be used by an analytics module 320 to generate several manners of data for use in the system. An operator may enter various analytical constraints and parameters using the operator input 322. The analytics module 320 may be manipulated such operator input to yield a desired analysis of the records stored in FACT_LEAD_ACTIVITY 330. Generally speaking, the data that may be assembled from the FACT_LEAD_ACTIVITY list 330 includes indexed referrals data 334 and indexed move-ins data 336. Such assembled data may be used to generate various cost and demand indexes and probabilities for a specialty property market across the several geographic, economic, and demographic categories. This useful indexed data across the operator desired constraints and parameters may then be communicated to other computing devices via communications module 340.

With the assembly of collected data in place from the various assembled lists index lists DIM_PROPERY 326, DIM_LEAD 325, DIM_GEOGRAPHY 327 and FACT_LEAD_ACTIVITY 330, several versions of an overall Demand Index may be realized in the following embodiments:

First for each LEAD_ID, a demand index generation algorithm may count the number of referrals in FACT_LEAD_ACTIVITY 330 to a given type of specialty property (e.g., assisted living vs. independent living for senior living communities). Then the algorithm may combine the property-type-specific referral counts with the lead attributes in DIM_LEAD 325 to create a list of predictive features for each LEAD_ID.

For each LEAD_ID with at least six months of risk to the exposure of moving into a specialty property, the algorithm may assess whether a lead moved into each of a range of specialty property types of interest (e.g., assisted living vs. independent living vs. senior apartments) within a specified period of months (e.g., six months in this embodiment). From this culled data, the algorithm may build and optimize a machine-learning sub-algorithm (e.g., a random forest algorithm in this embodiment) that predicts the probability of moving into a given type of specialty property, as well as the probability of not moving at all, using training and validation samples of the predictive features and outcome data assembled in previous steps, plus other features such as the date and location of the referral. The machine-learning algorithm may be used to further predict the property-type-specific move-in probabilities of all leads in DIM_LEAD 325. Then, each lead has a vector p of predicted move-in probabilities (plus an element pₙ for the probability of not moving at all).

Using all elements of

p|_{p≠p}_{ₙ},

The machine learning algorithm may estimate the conditional probability of moving into property type x given any move at all as:

$${q}_{x} = \frac{{p}_{x}}{{\sum }_{i \neq n} {p}_{i}} .$$

to measure the property-type-specific demand at time t (e.g., a month and year in this embodiment) for each property type x in a given location g, the sum of the conditional probabilities qₓ across all leads referred at time t in location g. The algorithm may then fit Bayesian structural time series models to each of the property-type- and location-specific demand time series developed. From the Bayesian structural time series models, the algorithm generates probabilistic forecasts of property-type-specific demand for h time points into the future. From the time series created and the forecasts, the algorithm generate year-over-year growth estimates for each time point, defined as the percentage change in property-type-specific demand from date d in year y to the same date in year y+1. This may be repeated for the trend components of the fitted Bayesian structural time series. The resultant data is termed as a mid-stage demand index based on specialty property referrals.

A similar process follows for the production of a late-stage Demand Index based on per-period move-in counts. Yet because property type is known for move-ins, the property-type prediction step is unnecessary, and one can proceed directly with counting the number of move-ins per time period, building the Bayesian structural time series, and computing the year-over-year growth estimates.

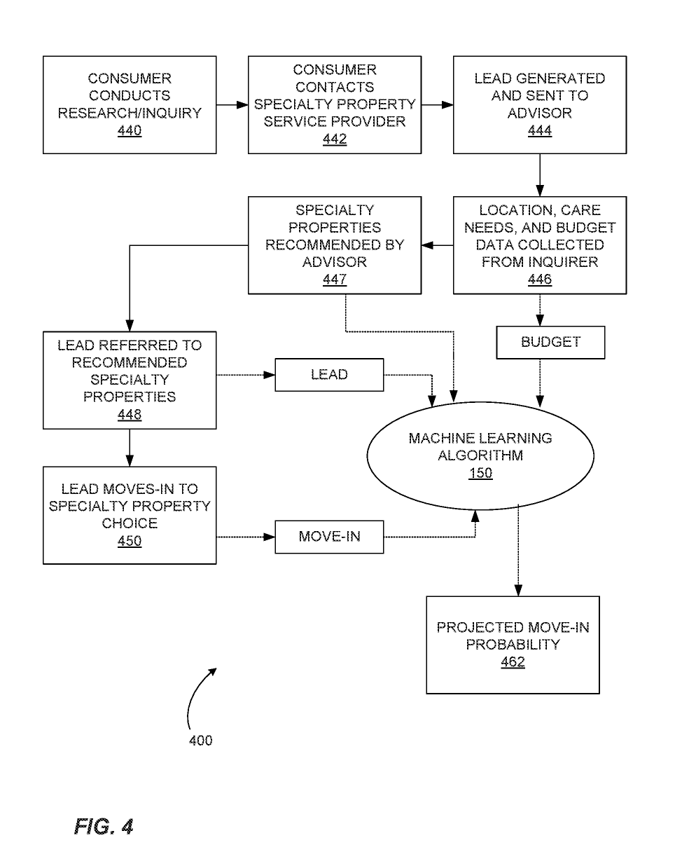

FIG. 4 is a method flow chart 400 for demand index data generation using the system of FIGS. 1-3 according to an embodiment of the subject matter disclosed herein. The method may begin when a prospective consumer initially conducts research and chooses to engage with a service provider for specialty properties that may be available at step 440. Such engagement may occur at step 442 through use of a user computer in sending a communication to an organization facilitating services for specialty properties. Once contact is made, a “lead” is generated wherein an advisor may become involved to facilitate a data collection process at step 444. The advisor may be an employee of the service-facilitation company or may be a third-party entity conducting data collection and lead follow-up on behalf of the facilitation company.

Regardless of the entity conducting the data collection, the event of the inquiry is converted into an indexed record at step 446 that includes various attributes about the inquiry, such as the inquirer's desired budget, desired service level or care needs, desired location, age, time-horizon and the like. Based on the provided data, the advisor may recommend a series of potential properties to the lead at step 447. Some of this initially collected data, such as budget data, may be sent to a machine-learning algorithm 150 at the time the data is collected. This data may be used to populate and/or update DIM_LEAD 325 as discussed above with respect to FIG. 3.

As various properties are recommended at step 448, each recommendation generates a “Lead Referral” (which is a tracked activity in FACT_LEAD_ACTIVITY 330) that includes sending lead data to the machine-learning algorithm 150. Further yet, as various leads actually move in to a recommended property at step 450, each move-in generates a “Move-In” event (which is also a tracked activity FACT_LEAD_ACTIVITY 330) that includes sending move-in data to the machine-learning algorithm 150. With all this indexed data being input to the machine-learning algorithm 150, analytics can be used to determine future demand for various property types in the form of projected move-in probability at step 462. Put another way, a specialty-property demand index may be generated based on all past and current data collected through the method of FIG. 4. As this demand index data is in an indexed form, various probabilities may be drawn out for subsets of the data as well. Such a subset demand probability may include a demand for properties in a specific geographic region, a demand for a specific type if property, a demand for properties within a specific budget, and the like. That is, the demand index, together with the analytical module of the machine-learning algorithm 150 may predict a vast number of probabilities based on current and historical data.

The example given above with respect to FIG. 3 provides an example embodiment of the algorithm embodied in the flow chart of FIG. 4. A skilled artisan will appreciate that the algorithm may be varied to provide any number of permutations of the collected date in terms of a specific styled demand index. The detailed example above referred to a mid-stage demand index as well as briefly describing a late-stage demand index. Additional permutations of the collected data are contemplated but not discussed in greater detail for brevity. For example, an acquisition manager may be interested in determining a specific market in which to expand. Thus, the methods and algorithms described above may be used to compare forecasts of growth and relative volume in any given set of markets. This allows for a comparison of the markets based on the demand stage of interest.

Another example includes a health care REIT aiming to compare its senior living portfolio to a broader market. Thus, the methods and algorithms disclosed herein provide a means for looking at different growth rates across markets as well as market share growth by location. The health care REIT may check comparison stability across various demand stages in various markets.

Yet another example includes a health care REIT wishing to understand which markets may be performing best among consumers with large budgets. Thus, the method and algorithms described above may be used to compare forecasts on a budget category basis. Such a comparison may reveal a specific consumer budget category that exhibits superior demand growth.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments and does not pose a limitation to the scope of the disclosure unless otherwise claimed. No language in the specification should be construed as indicating any non-claimed element as essential to each embodiment of the present disclosure.

Different arrangements of the components depicted in the drawings or described above, as well as components and steps not shown or described are possible. Similarly, some features and sub-combinations are useful and may be employed without reference to other features and sub-combinations. Embodiments have been described for illustrative and not restrictive purposes, and alternative embodiments will become apparent to readers of this patent. Accordingly, the present subject matter is not limited to the embodiments described above or depicted in the drawings, and various embodiments and modifications can be made without departing from the scope of the claims below.

What is claimed is:

1. A computer-based method, comprising:
establishing a demand index for specialty properties at a server computer;
receiving data about a plurality of inquiries from one or more remote computers, each inquiry including inquiry attributes about at least one type of specialty property at the server computer having an index of data about a plurality of specialty properties each within at least one grouping of types of specialty properties;
receiving data about a plurality of leads from one or more remote computers, each lead including lead attributes about at least one type of specialty property at a server computer having an index of data about a plurality of specialty properties each within at least one grouping of types of specialty properties;
receiving data about a plurality of move-ins from one or more remote computers, each move-in including move-in attributes about at least one type of specialty property at a server computer having an index of data about a plurality of specialty properties each within at least one grouping of types of specialty properties;
assimilating the inquiries attributes data, the leads attributes data, and the move-ins attributes data into the index;
generating, at the server computer, a probability of a move-in corresponding to the inquiry in response to receiving a new inquiry based on the demand index being updated by the attribute data of the new inquiry; and
communicating the probability to a remote computer unaffiliated with the inquiry.

2. The computer-based method of claim 1, wherein at least one of the specialty properties comprises an assisted living specialty property.

3. The computer-based method of claim 1, wherein at least one of the specialty properties comprises a long-term care specialty property.

4. The computer-based method of claim 1, wherein at least one inquiry attribute comprises one of the group consisting of: a monetary budget, a geographic location, a care needs characterization, and a date.

5. The computer-based method of claim 1, wherein at least one lead attribute comprises one of the group consisting of: a monetary budget, a geographic location, a care needs characterization, and a date.

6. The computer-based method of claim 1, wherein at least one move-in attribute comprises one of the group consisting of: a monetary budget, a geographic location, a care needs characterization, and a date.

7. The computer-based method of claim 1, further comprising delineating the demand index data by specific geographic region and limiting attribute data used in generating the move-in probability to demand index data corresponding to one delineated geographic region.

8. The computer-based method of claim 1, further comprising delineating the demand index data by specific demographics and limiting attribute data used in generating the move-in probability to demand index data corresponding to one delineated demographic.

9. The computer-based method of claim 1, further comprising delineating the demand index data by specific econometrics and limiting attribute data used in generating the move-in probability to demand index data corresponding to one delineated econometric.

10. A computer system, comprising:
a remote user computer coupled to a computer network and configured to collect inquiry data from a user inquiring about one or more specialty properties;
a remote adviser computer coupled to a computer network and configured to collect lead data from an adviser generating a lead in response to an inquiry about one or more specialty properties;
a remote manager computer coupled to a computer network and configured to collect move-in data from a manager verifying a move-in event in response to a lead about one or more specialty properties; and
a server computer coupled to the computer network and configured to assimilate the inquiry data, the lead data, and the move-in data into a demand index stored on the server computer, the demand index iteratively updated with assimilation of each new inquiry data set, lead data set or move-in data set.

11. The computer system of claim 10, wherein at least one of the specialty properties comprises an assisted living specialty property.

12. The computer system of claim 10, wherein at least one of the specialty properties comprises a long-term care specialty property.

13. The computer system of claim 10, wherein at least one inquiry attribute comprises one of the group consisting of: a monetary budget, a geographic location, a care needs characterization, and a date.

14. The computer system of claim 10, wherein at least one lead attribute comprises one of the group consisting of: a monetary budget, a geographic location, a care needs characterization, and a date.

15. The computer system of claim 10, wherein at least one move-in attribute comprises one of the group consisting of: a monetary budget, a geographic location, a care needs characterization, and a date.

16. A computing device; comprising:
an inquiry data collection module configured to collect inquiry attributes about one or more inquiries about one or more specialty properties;
a lead data collection module configured to collect lead attributes about one or more leads generated in response to the one or more inquiries;
a move-in data collection module configured to collect move-in attributes about one or more leads generated in response to the one or more leads; and
a machine-learning module configured to assimilate the collected attributes about the one or more inquiries, the one or more leads, and the one or more move-ins and configured to update a demand index in response to the assimilation of each attribute.

17. The computing device of claim 16, wherein each attribute comprises one of the group consisting of: a monetary budget, a geographic location, a care needs characterization, and a date.

18. The computing device of claim 16, further comprising a communication module configured to communicate a probability to a remote computing device, the probability including a probability of a move-in event in response to an inquiry based upon a current version of the demand index.

19. The computing device of claim 16, further comprising a communication module configured to communicate a probability to a remote computing device, the probability including a probability of a move-in event in response to a lead based upon a current version of the demand index.

20. The computing device of claim 16, further comprising a communication module configured to communicate a trend to a remote computing device, the trend including a probability of at least one future move-in event in response to at least one future inquiry based upon a current version of the demand index.
